(19) United States
(12) Patent Application Publication
(10) Pub. No.: US 2026/0034828 A1
(43) Pub. Date: Feb. 5, 2026

(54) MECHANICAL PENCIL

(71) Applicant: MITSUBISHI PENCIL COMPANY, LIMITED, Tokyo (JP)

(72) Inventor: Hirotake IZAWA, Tokyo (JP)

(73) Assignee: MITSUBISHI PENCIL COMPANY, LIMITED, Tokyo (JP)

(21) Appl. No.: 18/993,398

(22) PCT Filed: Oct. 23, 2023
(86) PCT No.: PCT/JP2023/038186

§ 371 Date: Jan. 10, 2025

(30) Foreign Application Priority Data
Oct. 24, 2022 (JP) 2022-170093

(51) Int. Cl. B43K 21/16; B43K 21/22

(52) U.S. Cl. CPC B43K 21/16; B43K 21/22

(57) ABSTRACT

A mechanical pencil 1 has a first cam surface 140a, a second cam surface 140b, a first fixed cam surface 141a that cooperates with the first cam surface to cause a rotating element to rotate, and a second fixed cam surface that cooperates with the second cam surface to cause a rotating element to rotate. The first cam surface is provided with first cam teeth 140aa, the second cam surface is provided with second cam teeth 140ba, the first fixed cam surface is provided with first fixed cam teeth 141aa that cooperate with the first cam teeth, and the second fixed cam surface is provided with second fixed cam teeth 142aa that cooperate with the second cam teeth. The first cam teeth are configured such that in each first cam tooth, the relationship 0<Y<X is achieved, where, with respect to a perpendicular line drawn from the apex, X is the length of the base on the rear side with respect to the rotating direction of the rotating element 140, and Y is the length of the base on the front side with respect to the rotating direction of the rotating element.

### FIELD

The present invention relates to a mechanical pencil.

### BACKGROUND

Known in the art is a mechanical pencil comprised of a rotating member including a slider provided with a chuck allowing advance and preventing retraction of a writing lead and of a rotation drive mechanism having a rotor and driving the rotor for rotation in one direction by receiving an axial direction retracting operation due to writing pressure received by the writing lead gripped by the chuck and an axial direction advancing operation due to release of the writing pressure and configured so that the writing lead rotates by the chuck rotating by receiving rotation drive force of the rotor (PTL 1 and PTL 2).

In a mechanical pencil provided with a rotation drive mechanism such as described in PTL 1, usually, while slight, the writing lead is made to rotate by performing an advancing operation and retracting operation of the writing lead. The series of an advancing operation and retracting operation of the writing lead is referred to all together as a “cushion operation”. In the mechanical pencil described in PTL 1, for example, in the case of taking shorthand etc., such a cushion operation, in particular retraction of the writing lead, feels bothersome. Focusing on such an issue, it is made so that a user can freely switch between an on and off state of the rotation drive mechanism. A cushion operation by the rotation drive mechanism will be explained while referring to FIG. 12 and FIG. 13.

FIG. 12 is a schematic view for explaining a rotation drive action of the rotor 240 of a conventional rotation drive mechanism, while FIG. 13 is a schematic view for explaining a rotation drive action of the rotor 240 continuing from FIG. 12. The rotation drive mechanism has a rotor 240 formed in a cylindrical shape, an upper cam forming member 241 formed in a cylindrical shape, and a lower cam forming member 242 formed in a cylindrical shape. In FIG. 12 and FIG. 13, a first cam face 240a formed into a continuous sawtooth shape along the circumferential direction is formed in a ring shape at a rear end face of a surface formed by the upper side of the rotor 240, while in the same way as the rear end face, a second cam face 240b formed into a continuous sawtooth shape along the circumferential direction is formed in a ring shape at a front end face of a surface at the lower side of the rotor 240.

At the ring-shaped end face of the upper cam forming member 241 facing the first cam face 240a of the rotor 240, a first fixed cam face 241a made a continuous sawtooth shape along the circumferential direction is formed. At the ring-shaped end face of the lower cam forming member 242 facing the second cam face 240b of the rotor 240 as well, a second fixed cam face 242a made a continuous sawtooth shape along the circumferential direction is formed. The cam faces of the first cam face 240a and second cam face 240b formed at the rotor 240 and the cam faces of the first fixed cam face 241a formed at the upper cam forming member 241 and the second fixed cam face 242a formed at the lower cam forming member 242 are formed so that the pitches in the circumferential direction become substantially the same as each other.

The rotation drive mechanism converts a retracting operation and advancing operation (cushion operation) of the writing lead due to a writing operation transmitted to the rotation drive mechanism to rotational motion of the rotor 240. The rotational motion of the rotor 240 is transmitted to the chuck unit in the state gripping the writing lead. Therefore, the writing lead held by the chuck unit also rotates.

FIG. 12(A) shows the relationship of the rotor 240, upper cam forming member 241, and lower cam forming member 242 in the state where writing pressure is not applied to the writing lead. In this state, the second cam face 240b formed at the rotor 240 abuts against the second fixed cam face 242a of the lower cam forming member 242 due to the biasing force of a not shown spring. At this time, the first cam face 240a of the rotor 240 and the first fixed cam face 241a of the upper cam forming member 241 are provided so as to be in a relationship offset in the axial direction by half a phase with respect to one tooth of the cam.

FIG. 12(B) shows the initial state where writing pressure is applied to the writing lead for writing by the mechanical pencil. In this state, the rotor 240 retracts against the biasing force of the spring along with retraction of the chuck unit. Due to this, the rotor 240 moves to the upper cam forming member 241 side and abuts against the first fixed cam face 241a.

Next, FIG. 12(C) shows the state when further writing pressure is applied to the writing lead and the rotor 240 abuts against the first fixed cam face 241a of the upper cam forming member 241 and slides against it while retracting. That is, the rotor 240 receives a rotation drive action corresponding to half a phase of one tooth of the first cam face 240a. In this state, the first cam face 240a of the rotor 240 engages with the first fixed cam face 241a of the upper cam forming member 241.

Note that, the circlemark drawn at the center of the rotor 240 in FIG. 12 and FIG. 13 shows the amount of rotational movement of the rotor 240. Further, in the state shown in FIG. 12(C), the second cam face 240b of the rotor 240 and the second fixed cam face 242a of the lower cam forming member 242 are set to be in a relationship offset in the axial direction by half a phase with respect to one tooth of the cam.

Next, FIG. 13(D) shows the initial state where writing by the mechanical pencil ends and the writing pressure on the writing lead is released. In this state, the rotor 240 advances due to the biasing force of the spring. Due to this, the rotor 240 moves to the lower cam forming member 242 side and abuts against the second fixed cam face 242a.

Next, FIG. 13(E) shows the state where the rotor 240 abuts against the second fixed cam face 242a of the lower cam forming member 242 due to the biasing force of the spring and slides against it while advancing. That is, the rotor 240 again receives a rotation drive action corresponding to half a phase of one tooth of the second cam face 240b. In this state, the second cam face 240b of the rotor 240 engages with the second fixed cam face 242a of the lower cam forming member 242.

Therefore, as shown by the circle mark drawn at the center part of the rotor 240, along with the reciprocating motion in the axial direction of the rotor 240 receiving the writing pressure, that is, the front-back motion, the rotor 240 receives a rotation drive action corresponding to one tooth of the first cam face 240a and second cam face 240b and is driven to rotate through the chuck unit in the same way as the writing lead gripped by the same. Therefore, due to one front-back motion in the axial direction of the rotor 240 due to writing, the rotor 240 receives rotational motion corresponding to one tooth of the cam. By repeating this, the writing lead is successively driven to rotate. For this reason, it is possible to prevent the writing lead from becoming worn in an uneven manner along with progress in writing and possible to prevent the thickness of the written lines or darkness of the written lines from greatly changing.

### CITATIONS LIST

### Patent Literature

[PTL 1] Japanese Unexamined Patent Publication No. 2022-073560
[PTL 2] WO2007/142135

### SUMMARY

### Technical Problem

As explained above, in PTL 1, the issue of the drop in the feel in writing due to the cushion operation sometimes feeling bothersome was focused on. The issue was solved by enabling the rotation drive mechanism to be turned off'in accordance with need so that the cushion operation itself was not performed. However, in PTL 1, the issue of reevaluating the cushion operation itself is not found. The advancing operation of the writing lead is performed along with the writing lead being lifted from the writing surface at the time of writing, so is not noticed by a user much at all. On the other hand, in the retracting operation of the writing lead, regardless of making the writing lead contact the writing surface when trying to write, the body of the mechanical pencil advances, so, in other words, the writing lead relatively retracts, so the user sometimes feels odd visually or tactilely.

In relation to this, the inventors collected negative and positive opinions by a survey regarding a mechanical pencil provided with a rotation drive mechanism for making a writing lead rotate. Out of the resultant 21.4% negative opinions, in fact 44.8% of the users gave retraction of the writing lead as the reason for the negative opinion. On the other hand, 78.6% of the users positively evaluated such a mechanical pencil, so the function of making the writing lead rotate is highly evaluated. Therefore, the inventors found that a cushion operation is necessary for making the writing lead rotate by the rotation drive mechanism and came up with the idea of reducing the amount of the cushion operation more, in particular reducing the amount of retraction of the writing lead until the limit.

The amount of the cushion operation or the amount of retraction of the writing lead will be explained while referring to FIG. 12(A). The height of the cam teeth is the distance “h” and the amount of movement until the front ends of the cam teeth of the first cam face 240a abut against the first fixed cam face 241a due to retraction of the rotor 240 is the distance “d”. The distance “s” in the axial direction between the rear end of the first cam face 240a of the rotor 240, that is, the front ends of the peaks of the cam teeth, and the parts of the valleys of the cam teeth of the first fixed cam face 241a of the upper cam forming member 241 corresponds to the amount of retraction of the writing lead at a cushion operation.

In FIG. 12(A), the second cam face 240b of the rotor 240 engages with the second fixed cam face 242a of the lower cam forming member 242, so to release this engagement, it is necessary at least that the front ends of the cam teeth of the second cam face 240b go beyond the front ends of the cam teeth of the second fixed cam face 242a. In other words, it is necessary to make the rotor 240 and in turn the writing lead retract by exactly the distance “h” of the cam teeth. If the distance “d” is smaller than the distance “h”, the rotation of the rotor 240 is obstructed by the first fixed cam face 241a or the second fixed cam face 242a, so this does not function as a rotation drive mechanism. Therefore, if the rotor 240 retracts further over the distance “h” of the cam teeth, the distance corresponding to the distance d-h shows that there is room for decreasing the amount of retraction of the writing lead.

The present invention has as its object to provide a mechanical pencil provided with a rotation drive mechanism for making a writing lead rotate wherein an amount of retraction of the writing lead is further reduced.

### Solution to Problem

According to one aspect of the present invention, there is provided a mechanical pencil comprising a shaft barrel, a chuck unit allowing advance and preventing retraction of a writing lead, and a rotation drive mechanism having a rotor and receiving an axial direction retracting operation due to writing pressure received by the writing lead gripped by the chuck unit and axial direction advancing operation due to release of the writing pressure to make the rotor be driven to rotate in one direction, the rotation drive mechanism having a ring-shaped first cam face formed at a rear end face of the rotor, a ring-shaped second cam face formed at a front end face of the rotor, a first fixed cam face provided at the shaft barrel side and cooperating with the first cam face to make the rotor rotate, and a second fixed cam face provided at the shaft barrel side and cooperating with the second cam face to make the rotor rotate, the retracting operation of the chuck unit due to the writing pressure causing the first cam face of the rotor to abut against the first fixed cam face and engage with it while making the rotor rotate and the release of the writing pressure causing the second cam face of the rotor to abut against the second fixed cam face and engage with it while making the rotor rotate, in the state where the first cam face of the rotor is made to engage with the first fixed cam face, the second cam face and the second fixed cam face being set to a relationship offset in the axial direction by exactly half a phase with respect to one tooth of the cam, while in the state where the second cam face of the rotor is made to engage with the second fixed cam face, the first cam face and the first fixed cam face being set to a relationship offset in the axial direction by exactly half a phase with respect to one tooth of the cam, the first cam face provided with first cam teeth, the second cam face provided with second cam teeth, the first fixed cam face provided with first fixed cam teeth cooperating with the first cam teeth, and the second fixed cam face with second fixed cam teeth cooperating with the second cam teeth, the first cam teeth configured so that when, at the first cam teeth, with respect to a vertical drawn from the vertex, a length of a bottom side at a rear side with respect to a rotational direction of the rotor is X and a length of a bottom side at a front side with respect to a rotational direction of the rotor is Y, the relationship of 0<Y<X stands.

According to another aspect, the first cam teeth and the second cam teeth are configured so that the relationship of X/Y≥1.72 stands.

Further, according to another aspect, the first cam teeth and the second cam teeth are configured so that the relationship of X/Y≥2.0 stands.

Further, according to another aspect, in the state where the second cam face of the rotor is made to engage with the second fixed cam face, the vertexes of the first cam face and the vertexes of the first fixed cam face are separated by 0.1 mm or more in the circumferential direction.

Further, according to another aspect, the first fixed cam face and the second fixed cam face are arranged at a shortest distance at which rotation of the rotor is not obstructed.

Further, according to another aspect, the writing lead rotates by the chuck unit rotating receiving the rotation drive force of the rotor.

### ADVANTAGEOUS EFFECTS OF INVENTION

According to the aspects of the present invention, the common advantageous effect is exhibited that a mechanical pencil provided with a rotation drive mechanism for making a writing lead rotate in which an amount of retraction of the writing lead is further reduced is provided.

### BRIEF DESCRIPTION OF DRAWINGS

FIG. 1 is a vertical cross-sectional view of a mechanical pencil according to an embodiment of the present invention.

FIG. 2 is an enlarged cross-sectional view of a front half of the mechanical pencil of FIG. 1.

FIG. 3 is an enlarged cross-sectional view of a center part of the mechanical pencil of FIG. 1.

FIG. 4 is a partial enlarged view of a rotation drive mechanism.

FIG. 5 is a view for explaining in order a rotation drive operation of a rotor of a rotation drive mechanism.

FIG. 6 is a schematic view for explaining in order a rotation drive operation of a rotor of a rotation drive mechanism.

FIG. 7 is a schematic view for explaining a relationship of cams of a rotation drive mechanism.

FIG. 8 is a view for explaining offset of a rotor.

FIG. 9 is a view for explaining poor rotation of a rotor.

FIG. 10 is a schematic view for explaining a relationship of cams of another rotation drive mechanism.

FIG. 11 is a schematic view for explaining in order a rotation drive operation of a rotor of a rotation drive mechanism of FIG. 10.

FIG. 12 is a schematic view for explaining a rotation drive operation of a rotor of a conventional rotation drive mechanism.

FIG. 13 is a schematic view for explaining a rotation drive operation of a rotor continuing from FIG. 12.

### DESCRIPTION OF EMBODIMENTS

Below, while referring to the drawings, embodiments of the present invention will be explained. Throughout the figures, corresponding component elements will be assigned common reference notations.

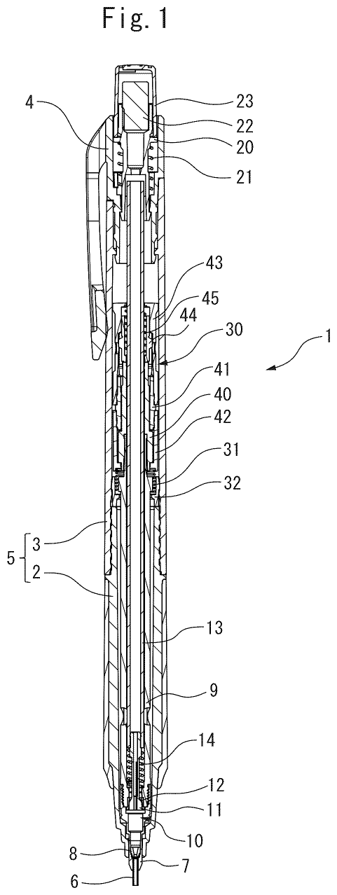

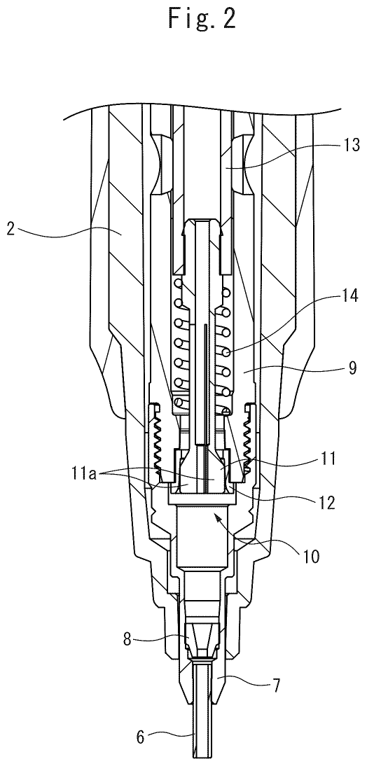

FIG. 1 is a vertical cross-sectional view of a mechanical pencil I according to an embodiment of the present invention. FIG. 2 is an enlarged cross-sectional view of a front half of the mechanical pencil 1 of FIG. 1.

The mechanical pencil 1 has a front shaft 2, a rear shaft 3 screwed over the outer circumferential surface of the rear end part of the front shaft 2, and an inside barrel 4 snap fit in an inner circumferential surface of the rear end part of the rear shaft 3 and provided with a clip. The front shaft 2 and the rear shaft 3 form the shaft barrel 5. Note that, including also the inside barrel 4, these are also called the “shaft barrel 5”. The mechanical pencil 1 is configured so that the writing lead projects out from the front end of the shaft barrel 5. The vicinity of the front end of the shaft barrel 5 is covered by a front end pipe 6 guiding the writing lead. In this Description, in the axial direction of the mechanical pencil 1, the writing lead side is defined as the “front” side while the side opposite to the writing lead side is defined as the “rear” side.

At the inside of the front end part of the shaft barrel 5, a slider 7 is arranged able to slide in the axial direction and able to rotate about its axis. The slider 7 is formed into a cylindrical shape with an outside diameter becoming narrower in stages toward the front. At the front end part of the slider 7, the above-mentioned front end pipe 6 is attached. Further, at the rear of the front end pipe 6, a holding chuck 8 formed with a through hole at its center is arranged. The through hole of the holding chuck 8 acts to slidingly contact the outer circumferential surface of the writing lead and temporarily hold the writing lead.

At the rear end part of the slider 7, a relay member 9 formed in a cylindrical shape is screwed. At the insides of the slider 7 and relay member 9, a chuck unit 10 gripping the writing lead and lead case 13 are arranged. The chuck unit 10 has a chuck body 11 and a fastener 12 formed in a cylindrical shape so as to surround the front end part of the chuck body 11. At least the front half of the chuck body 11 is divided into three chuck pieces 11a along the axial direction. The through hole of the writing lead is formed along the center axis. The chuck pieces 11a are formed so that their front end parts are separated from each other. The lead case 13 is formed into a cylindrical shape and houses the writing lead inside it. At the inside of the front end part of the lead case 13, the rear end part of the chuck body 11 is inserted and snap fit.

A coil spring 14 is arranged so as to surround the chuck body 11. The front end of the coil spring 14 is supported by a step part formed at the inner circumferential surface of the relay member 9, while the rear end of the coil spring 14 abuts against the front end face of the lead case 13. Therefore, the coil spring 14 biases the lead case 13 and chuck body 11 to the rear. By having the chuck body 11 biased to the rear be housed in the fastener 12, the front end parts approach each other and the state of gripping the writing lead can be maintained. Further, if writing pressure is applied to the writing lead, the chuck body 11 retracts more and is housed in the fastener 12, while the writing lead is gripped by the chuck body 11. Due to this, retraction of the writing lead is prevented. On the other hand, if force acts pulling the writing lead out to the front, the chuck body 11 is not acted on by the fastener 12, so it is possible to pull the writing lead out to the front without resistance. That is, the chuck unit 10 acts to allow advance and prevent retraction of the writing lead, but so long as this action is exhibited, it may also be another chuck unit, for example, a ball chuck.

The outer circumferential surface of the fastener 12 is snap fit with the inner circumferential surface of the front end part of the relay member 9. Therefore, the slider 7, relay member 9, and chuck unit 10 can move inside the shaft barrel 5 in the axial direction. The rear end part of the relay member 9 is connected to a later explained rotation drive mechanism 30.

At the rear end part of the shaft barrel 5, specifically the rear end part of the inside barrel 4, as a click member, a tubular click member 20 is provided to be able to move back and forth with respect to the shaft barrel 5. The click member 20 is biased to the rear by the coil spring 21. At the inside of the front end part of the click member 20, the lead case 13 is inserted. At the inside of the rear end part of the click member 20, a rubber eraser 22 is attached in a detachable manner. At the outer circumferential surface of the rear end part of the click member 20, a click cover 23 is attached in a detachable manner whereby the rubber eraser 22 is protected from getting dirty etc.

The lead case 13 advances by a click operation pressing the click member 20 or the click cover 23 forward. Due to this, the chuck body 11 is pushed out to the front. Along with this, it acts to make the writing lead gripped by the chuck body 11 also advance and feed out the writing lead from the front end pipe 6. If releasing the pressure due to the click operation, due to the biasing force of the coil spring 21, the click member 20 retracts and returns to the original position. At this time, the chuck body 11 retracts due to the biasing force of the coil spring 14. On the other hand, the writing lead is held by a holding chuck 8 arranged inside the slider 7, so, as the action of the chuck unit 10, the writing lead is pulled out from the chuck body 11 without resistance. As a result, the writing lead is fed out from the front end pipe 6, so each time repeating this click operation, the writing lead can be fed out by a predetermined amount.

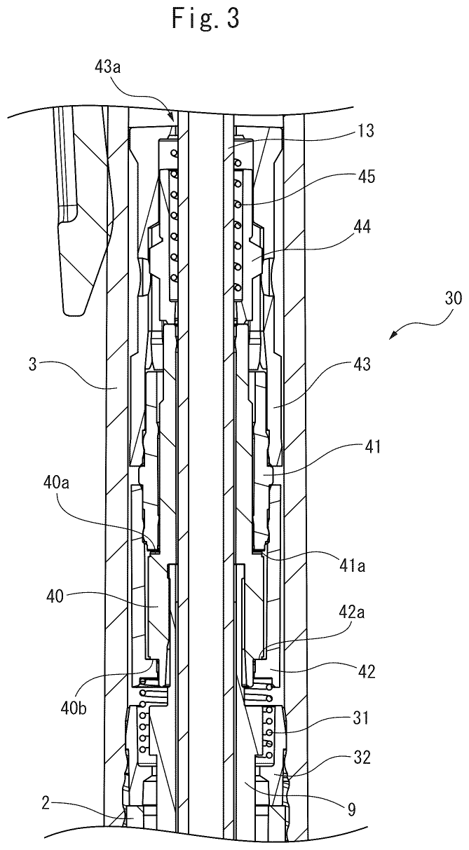

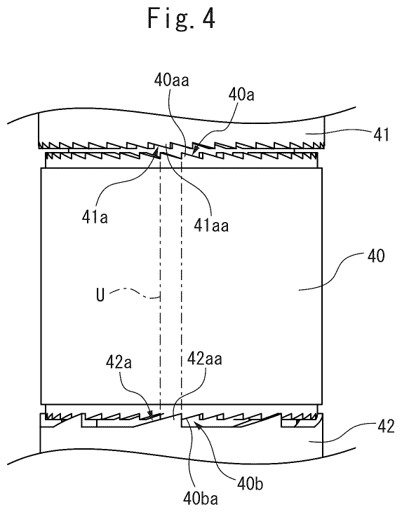

FIG. 3 is an enlarged cross-sectional view of a center part of the mechanical pencil 1 of FIG. 1, while FIG. 4 is a partial enlarged view of the rotation drive mechanism 30. The rotation drive mechanism 30 is arranged at an inside space of the rear shaft 3. The rotation drive mechanism 30 is connected to the rear end part of the relay member 9. Between the rear end face of the front shaft 2 and the front end face of the rotation drive mechanism 30, a shaft spring 31 is arranged. The rotation drive mechanism 30 is biased to the rear by this. The lead case 13 runs through the inside of the relay member 9 and rotation drive mechanism 30 and is separated from the rotation drive mechanism 30.

The rotation drive mechanism 30 has a rotor 40 formed in a cylindrical shape, an upper cam forming member 41 as a first cam forming member formed in a cylindrical shape, a lower cam forming member 42 as a second cam forming member formed in a cylindrical shape, a cylinder member 43 formed in a cylindrical shape, a torque canceller 44 formed in a cylindrical shape, and a coil-shaped cushion spring 45. The rotation drive mechanism 30 is made the unit of these members combined.

At an inner circumferential surface of the front end part of the rotor 40, an outer circumferential surface of the rear end part of the relay member 9 is snap fit. The vicinity of the front end part of the rotor 40 has a part formed in a flange shape of a just slightly larger diameter. At the rear end face of that part, a first cam face 40a is formed. At the front end face of the part, a second cam face 40b is formed.

The upper cam forming member 41 surrounds the rotor 40 at the back of the first cam face 40a of the rotor 40 to be able to turn. The lower cam forming member 42 is snap fit at the outer circumferential surface of the front end part of the upper cam forming member 41. At the front end face of the upper cam forming member 41 facing the first cam face 40a of the rotor 40, a first fixed cam face 41a is formed. At the inside surface of the front end part of the lower cam forming member 42 facing the second cam face 40b of the rotor 40, a second fixed cam face 42a is formed.

The first cam face 40a is provided with a plurality of first cam teeth 40aa, the second cam face 40b is provided with a plurality of second cam teeth 40ba, the first fixed cam face 41a is provided with a plurality of first fixed cam teeth 41aa, and the second fixed cam face 42a is provided with a plurality of second fixed cam teeth 42aa. The first cam teeth 40aa and first fixed cam teeth 41aa are the same in shape and the same in orientation. The first cam teeth 40aa and second cam teeth 40ba are the same in shape, but are line symmetric. The first cam teeth 40aa, second cam teeth 40ba, and first fixed cam teeth 41aa are continuously arranged without any gap along the circumferential direction at the corresponding cam faces. On the other hand, the second fixed cam teeth 42aa of the second fixed cam face 42a are similar shapes larger than the first cam teeth 40aa, second cam teeth 40ba, and first fixed cam teeth 41aa. Further, the second fixed cam teeth 42aa are arranged along the circumferential direction at equal intervals while separated from each other at the second fixed cam face 42a. The first cam face 40a is formed in a sawtooth shape by the plurality of first cam teeth 40aa, the second cam face 40b is formed in a sawtooth shape by the plurality of second cam teeth 40ba, and the first fixed cam face 41a is formed in a sawtooth shape by the plurality of first fixed cam teeth 41aa.

At the outer circumferential surface of the rear end part of the upper cam forming member 41, a cylinder member 43 formed into a cylindrical shape is snap fit. At the rear end part of the cylinder member 43, a through hole 43a through which the lead case 13 can be inserted is formed. Inside the cylinder member 43, a torque canceller 44 formed into a cylindrical shape and able to move in the axial direction is arranged. Between the inside surface of the front end part of the torque canceller 44 and the inside surface of the rear end part of the cylinder member 43, a cushion spring 45 is arranged. The cushion spring 45 biases the rotor 40 through the torque canceller 44.

Here, the relay member 9 transmits the retracting operation and advancing operation (cushion operation) of the writing lead due to a writing operation to the rotation drive mechanism 30, that is, the rotor 40, and transmits the rotational motion of the rotor 40 in the rotation drive mechanism 30 occurring due to the cushion operation to the chuck unit 10 in the state gripping the writing lead. Therefore, due to rotation of the relay member 9, the writing lead gripped by the chuck unit 10 also rotates.

Other than when writing by the mechanical pencil 1, that is, when writing pressure is not being applied to the writing lead, the rotor 40 is positioned at the front due to the biasing force of the cushion spring 45 through the torque canceller 44. Therefore, the second cam face 40b of the rotor 40 is rendered a state abutting and engaged with the second fixed cam face 42a. When writing by the mechanical pencil 1, that is, when writing pressure is being applied to the writing lead, the chuck unit 10 retracts against the biasing force of the cushion spring 45. Along with this, the rotor 40 also retracts. Therefore, the first cam face 40a of the rotor 40 is rendered a state abutting and engaged with the first fixed cam face 41a. The writing lead and the rotor 40 advance, retract, or rotate integrally.

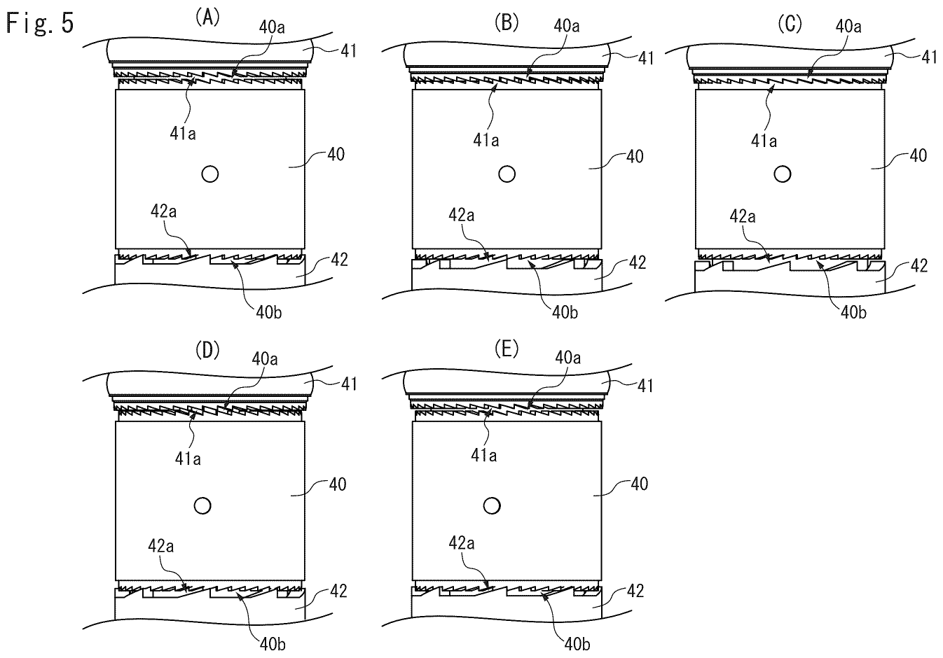

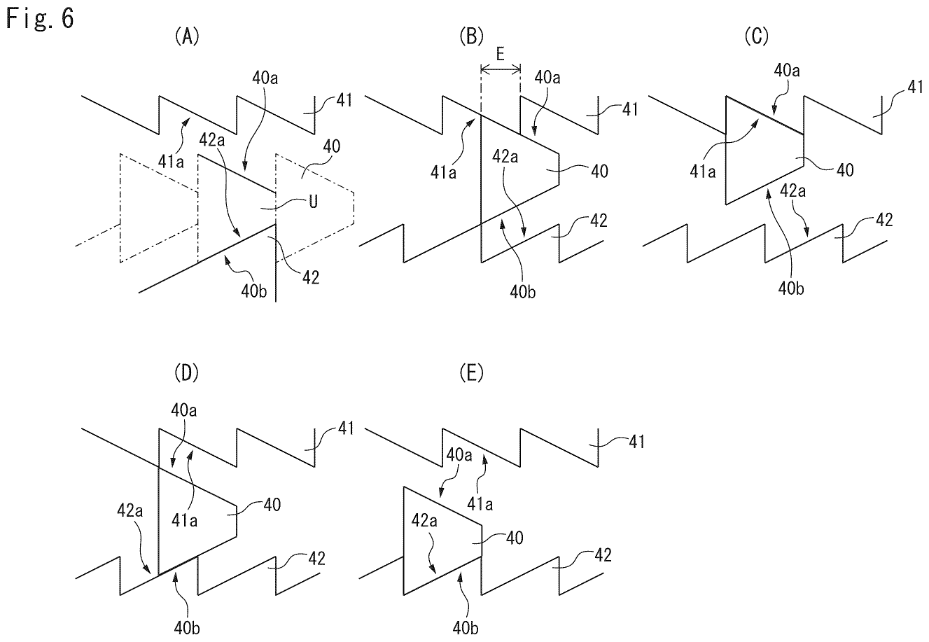

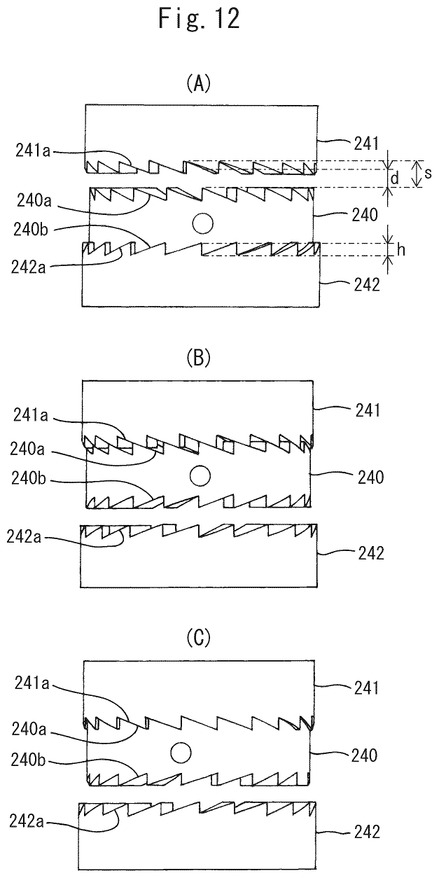

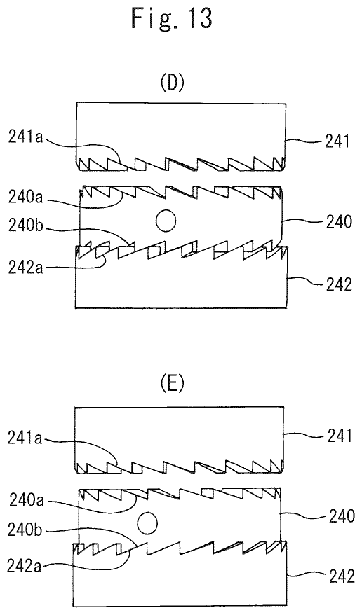

FIG. 5 is a view for explaining in order a rotation drive action of the rotor 40 of the rotation drive mechanism 30, while FIG. 6 is a schematic view for explaining in order a rotation drive action of the rotor 40 of the rotation drive mechanism 30. FIGS. 6(A) to (E) are schematic views respectively corresponding to FIGS. 5(A) to (E). Stated further, FIGS. 5(A) to (E) and FIGS. 6(A) to (E) respectively correspond to FIGS. 12(A) to (C) and FIGS. 13(D) and (E). FIG. 6 partially shows the state where the rotor 40, upper cam forming member 41, and lower cam forming member 42 are spread out in the circumferential direction. Further, to enable the cushion operation to be understood more easily, the cam teeth of the rotor 40 will be explained referring to a unit U of a single cam tooth surrounded by imaginary lines in FIG. 4.

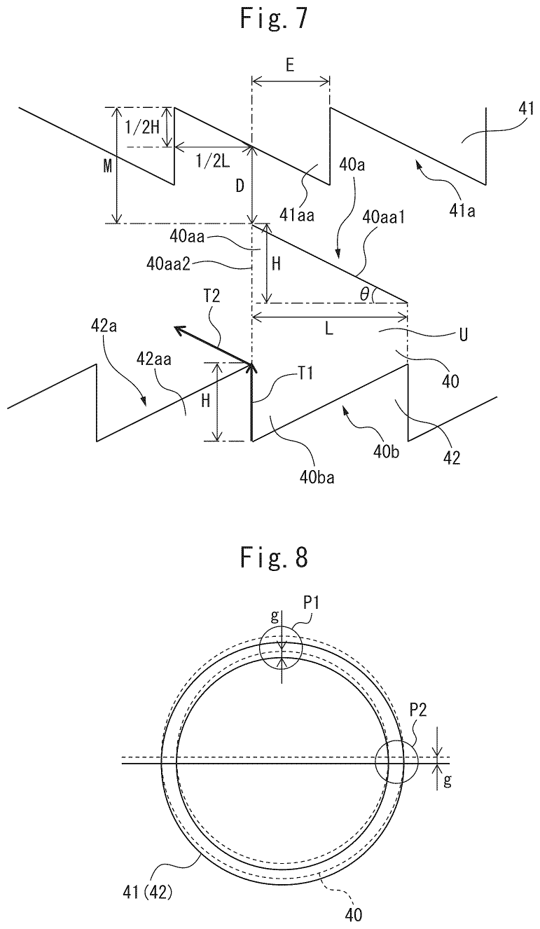

The second fixed cam teeth 42aa are shaped similarly to the other cam teeth, so seen from the functional viewpoint, are substantially equal to cam teeth of the same shape arranged continuously. Therefore, for example, in FIG. 6 and the later explained FIG. 7, to enable easy comparison with FIG. 12 and FIG. 13, the second fixed cam teeth 42aa are schematically shown similar to cam teeth of the same shape as other cam teeth and arranged continuously. Note that, the second fixed cam teeth 42aa may similarly be made the same shape as other cam teeth and be arranged continuously along the circumferential direction. Further, the first cam teeth 40aa, second cam teeth 40ba, and first fixed cam teeth 41aa are respectively arranged continuously along the circumferential direction, but may also be arranged separated along the circumferential direction. Seen from the functional viewpoint, they may be similar shapes with the other cam teeth.

FIG. 5(A) and FIG. 6(A) show the relationship of the advancing rotor 40, upper cam forming member 41, and lower cam forming member 42 in the state where writing pressure is not applied to the writing lead. In this state, the second cam face 40b formed at the rotor 40 abuts against the second fixed cam face 42a of the lower cam forming member 42 due to the biasing force of the cushion spring 45. At this time, the first cam face 40a of the rotor 40 and the first fixed cam face 41a of the upper cam forming member 41 are set to a relationship offset in the axial direction by half a phase with respect to one tooth of the cam.

FIG. 5(B) and FIG. 6(B) show the initial state where writing pressure is applied to the writing lead for writing by the mechanical pencil 1. In this state, the rotor 40 retracts while compressing the cushion spring 45 along with retraction of the chuck unit 10. Due to this, the rotor 40 moves to the upper cam forming member 41 side and abuts against the first fixed cam face 41a.

Next, FIG. 5(C) and FIG. 6(C) show the state where writing pressure is further applied to the writing lead and the rotor 40 abuts against the first fixed cam face 41a of the upper cam forming member 41 and slides against it while retracting. That is, the rotor 40 receives a rotation drive action corresponding to half a phase of one tooth of the first cam face 40a. In this state, the first cam face 40a of the rotor 40 engages with the first fixed cam face 41a of the upper cam forming member 41.

Note that, the circle mark drawn at the center part of the rotor 40 in FIG. 5 shows the amount of rotational movement of the rotor 40. Further, in the state shown in FIG. 5(C), the second cam face 40b of the rotor 40 and the second fixed cam face 42a of the lower cam forming member 42 are set so as to be offset in the axial direction by half a phase with respect to one tooth of the cam.

Next, FIG. 5(D) and FIG. 6(D) show the initial stage where writing by the mechanical pencil 1 ends and the writing pressure on the writing lead is released. In this state, the rotor 40 advances due to the biasing force of the cushion spring 45. Due to this, the rotor 40 moves to the lower cam forming member 42 side and abuts against the second fixed cam face 42a.

Next, FIG. 5(E) and FIG. 6(E) show the state where the rotor 40 abuts against the second fixed cam face 42a of the lower cam forming member 42 due to the biasing force of the cushion spring 45 and slides against it while advancing. That is, the rotor 40 again receives a rotation drive action corresponding to half a phase of one tooth of the second cam face 40b. In this state, the second cam face 40b of the rotor 40 engages with the second fixed cam face 42a of the lower cam forming member 42.

Therefore, as shown by the circle mark drawn at the center part of the rotor 40 at FIG. 5, along with reciprocating motion in the axial direction of the rotor 40 receiving writing pressure, that is, front-back motion, the rotor 40 receives a rotation drive action corresponding to one tooth of the first cam face 40a and second cam face 40b. Through the chuck unit 10, the writing lead gripped by this is driven to rotate in the same way. Therefore, due to one front-back motion in the axial direction of the rotor 40 due to writing, the rotor 40 receives a rotation drive action corresponding to one tooth of the cam. By repeating this, the writing lead is successively driven to rotate. For this reason, it is possible to prevent the writing lead from being unevenly worn along with progress in writing and possible to prevent the thickness of the written lines and the darkness of the written lines from greatly changing. Note that, the following explanation can also be applied to a mechanical pencil having a rotation drive mechanism, but not configured so that the writing lead rotates.

In short, the rotation drive mechanism 30 has a ring-shaped first cam face 40a formed at the rear end face of the rotor 40, a ring-shaped second cam face 40b formed at the front end face of the rotor 40, a first fixed cam face 41a provided at the shaft barrel 5 side and cooperating with the first cam face 40a to make the rotor 40 rotate, and a second fixed cam face 42a provided at the shaft barrel 5 side and cooperating with the second cam face 40b to make the rotor 40 rotate. It is configured so that the retracting operation of the chuck unit 10 due to the writing pressure causes the first cam face 40a of the rotor 40 to abut against the first fixed cam face 41a and engage with it while making the rotor 40 rotate and so that release of the writing pressure causes the second cam face 40b of the rotor 40 to abut against the second fixed cam face 42a and engage with it while making the rotor 40 rotate. In the state where the first cam face 40a of the rotor 40 is engaged with the first fixed cam face 41a, the second cam face 40b and second fixed cam face 42a are set in a relationship where they are offset in the axial direction by exactly half a phase with respect to one tooth of the cam, while in the state where the second cam face 40b of the rotor 40 is engaged with the second fixed cam face 42a, the first cam face 40a and first fixed cam face 41a are set in a relationship where they are offset in the axial direction by exactly half a phase with respect to one tooth of the cam.

Note that, the torque canceller 44 receiving the biasing force of the cushion spring 45 and pushing out the rotor 40 to the front causes sliding between its front end face and the rear end face of the rotor 40 and prevents rotational motion of the rotor 40 from being transmitted to the cushion spring 45. That is, due to the torque canceller 44, rotational motion of the rotor 40 is prevented from being transmitted to the cushion spring 45. Due to this, untwisting of the cushion spring 45 (torque) obstructing rotational motion of the rotor 40 is prevented from being generated.

Due to the above, the mechanical pencil 1 has a chuck unit 10 and a rotor 40 and is configured so as to be able to feed out the writing lead to the front by the release and grip of the writing lead due to the front-back motion of the chuck unit 10. It is configured so that the chuck unit 10 is held inside the shaft barrel 5 so as to be able to rotate about the center axis in the state holding the writing lead, makes the rotor 40 rotate by the front-back motion of the rotor 40 through the chuck unit 10 due to the writing pressure of the writing lead, and transmits the rotational motion of the rotor 40 through the chuck unit 10 to the writing lead.

FIG. 7 is a schematic view for explaining the relationship of the cams of the rotation drive mechanism 30 and is a view the same as FIG. 6(A). A first cam tooth 40aa of the first cam face 40a has a first slanted surface 40aa1 and a vertical surface 40aa2 corresponding to a second slanted surface. Due to the first slanted surface 40aa1 and vertical surface 40aa2 of the adjoining first cam tooth 40aa, the first cam face 40a is formed into a continuous sawtooth shape. The first slanted surface 40aa1 is a surface slanted by the slant angle θ with respect to the transverse direction perpendicular to the axial direction, while the vertical surface 40aa2 is a surface perpendicular to a surface parallel to the axial direction, that is, a surface perpendicular to the transverse direction. As explained above, the second cam tooth 40ba of the second cam face 40b and the first fixed cam tooth 41aa of the first fixed cam face 41a also have similar shapes.

The heights of the first cam tooth 40aa and second cam tooth 40ba and the height at which the second fixed cam tooth 42aa substantially engages with the second cam tooth 40ba correspond to the distance “h” of FIG. 12(A) and is designated as the distance H. The length of the vertical surface 40aa2 of the first cam tooth 40aa is equal to the height of the first cam tooth 40aa and therefore is equal to the distance H. The movement distance until the front end of the first cam tooth 40aa abuts against the first fixed cam tooth 41aa due to retraction of the rotor 40 is equivalent to the distance “d” of FIG. 12(A) and is designated as the distance D. The length along the circumferential direction of the first cam tooth 40aa is made the length L of a cam tooth.

Note that, the first cam tooth 40aa has a thickness in the radial direction corresponding to a member of the rotor 40 formed into a cylindrical shape. FIG. 6 and FIG. 7 schematically show states of the rotor 40, upper cam forming member 41, and lower cam forming member 42 spread out in the circumferential direction, but depending on which part in the range of thickness in the radial direction the first cam tooth 40aa is spread out at, strictly speaking, the angle and dimensions differ just slightly. Therefore, in FIG. 6 and FIG. 7 and the other explanations in this Description, it is assumed that the outermost side part defining the outside diameter of the rotor 40 is spread out in the circumferential direction and defines θ and L and the other angles and distances and the positional relationship of other members.

In the rotation drive mechanism 30 in the mechanical pencil 1, the first fixed cam face 41a and the second fixed cam face 42a are arranged at the shortest distance at which rotation of the rotor 40 is not obstructed. For this reason, they are configured so that the distance H of the height at which the second cam teeth 40ba and the second fixed cam teeth 42aa substantially engage and the distance D in the axial direction between the front ends of the first cam teeth 40aa and the first fixed cam teeth 41aa become equal.

In more detail, in FIG. 7 corresponding to FIG. 5(A) and FIG. 6(A), the rotor 40 is limited in rotation by the interlocking of the second cam teeth 40ba of the second cam face 40b and the second fixed cam teeth 42aa of the second fixed cam face 42a. If the rotor 40 retracts by exactly the distance H due to retraction of the writing lead from this state, the interlock of the second cam teeth 40ba and the second fixed cam teeth 42aa is released. Due to this, the limit on rotation of the rotor 40 is lifted. Further, if the rotor 40 retracts by exactly the distance D, the first slanted surfaces 40aa1 of the rotor 40 can abut against the first fixed cam teeth 41aa and thereby make the rotor 40 rotate.

In short, the state where the lifting of the restriction on rotation of the rotor 40 and the abutting of the first cam face 40a and first fixed cam face 41a are performed at the same time, that is, where the distance H and the distance D are equal (D=H), can be said to be a state where the first fixed cam face 41a and second fixed cam face 42a are arranged at the shortest distance where rotation of the rotor 40 is not obstructed. In other words, if the distance H and the distance D are equal, the amount of retraction “m” of the writing lead becomes the shortest. It is also possible to consider the allowable error at the time of production etc. and make the distance D become longer than the distance H by just a bit. The “shortest distance” only requires the intent of design so that rotation of the rotor is not obstructed be objectively or externally clear. It is judged after considering the allowable error at the time of production etc. It is judged not considering the wear due to use of the mechanical pencil.

As explained above, the first cam face 40a and the first fixed cam face 41a are arranged offset by half a phase with respect to one tooth of the cam. Therefore, the rotor 40 rotates by exactly the distance ½ L and retracts by exactly the distance ½ H from the state shown in FIG. 5(B) and FIG. 6(B) until reaching the state shown in FIG. 5(C) and FIG. 6(C). In short, in one cushion operation, the writing lead retracts by exactly the distance 3/2 H (=½ H+H). This is the minimum amount of retraction “m” of the writing lead of the rotation drive mechanism 30. The minimum amount of retraction “m” found geometrically is made the minimum amount of retraction M. Only naturally, the amount of movement in the axial direction from the state where the rotor 40 was retracted (FIG. 5(C) and FIG. 6(C)) to the advanced state (FIG. 5(E) and FIG. 6(E)), that is the amount of advance, is the distance 3/2 H the same as the minimum amount of retraction M.

Note that, if focusing on the motion of the front end of a peak of a second cam tooth 40ba of the second cam face 40b, when first retracting, it moves along the path T1, then moves along the path T2 due to subsequent rotation and retraction. A first cam tooth 40aa of the first cam face 40a moves while following a similar path as this.

The distance H depends on the slant angle θ of the first cam tooth 40aa and the length L in the circumferential direction and is in the relationship H=L tan θ. For this reason, it is possible to make the length L of the cam tooth smaller or to make the slant angle θ smaller to reduce the distance H and as a result to reduce the minimum amount of retraction M more. Therefore, design of the slant angle θ and the length L of a cam tooth will be explained.

The slant angle θ is one factor determining the ease of cam teeth to slide with each other by its size. That is, if the slant angle θ is too small, for example, if the slant angle θ is smaller than the friction angle, the cam teeth will not slide and therefore the rotor 40 will not rotate. If the slant angle θ is too large, the distance H becomes larger and the minimum amount of retraction M also becomes larger. Considering the materials being used as parts for writing implements as a whole, the slant angle θ is preferably 8 to 25° in range.

In general, most of the components of mechanical pencils and other writing implements are formed by polypropylene, polyacetal, or other plastics. In particular, inside parts complicated in shape and not having an effect on the outside appearance such as the cam structures of the rotor 40, upper cam forming member 41 and lower cam forming member 42 are almost never formed by metal materials. To make the cooperating motions of the cam teeth formed at these parts, specifically the rotor 40 abutting against the upper cam forming member 41 or the lower cam forming member 42 and sliding against it while rotating, more reliable considering in particular the frictional resistance, a slant angle θ larger than the friction angle at the cam teeth is necessary. For example, the rotor 40, the upper cam forming member 41 and lower cam forming member 42 are made of polyacetal and the friction angle is made 10.2°. That is, if the slant angle θ is 10.2° or less, the cam teeth will not slide and therefore the rotor 40 cannot be made to rotate.

The length L of a cam tooth is calculated by calculating the length of the entire circumference from the outside diameter of the rotor 40 (outside diameter×π) and dividing it by the number of cam teeth. One example of the design of the outside diameter and other dimensions of the rotor 40 will be explained. A 0.5 mm writing lead is allowed to have up to an outside diameter of 0.58 mm according to JIS standard S6005 for mechanical pencil leads. If able to house several writing leads in the lead case 13, the inside diameter of the lead case 13 has to be at least exactly 1.8 mm, for example, for three writing leads. A plastic member, from the viewpoint of strength, bas a thickness of the cylindrical part of at least 0.5 mm. Therefore, the thickness of the lead case 13, the thickness of the rotor 40 of the part surrounding the lead case 13, and further the thickness of the part at which the cam teeth are formed are respectively made 0.5 mm. Considering these thicknesses and the inside diameter of the lead case 13, the outside diameter of the part of the first cam face 40a and second cam face 40b of the rotor 40 becomes 4.8 mm.

The number of cam teeth of the first cam face 40a, that is, the number of cam teeth of the corresponding second cam face 40b, is preferably 20 to 90. The number of cam teeth defines the rotational angle of the writing lead rotating due to one cushion operation. For example, if there are 90 cam teeth, 360° divided by 90 gives 4°, so the rotor 40 rotates by exactly 4° by one cushion operation. Therefore, if writing 90 strokes, the writing lead rotates by 1 turn.

If there are more than 90 cam teeth, the rotational angle becomes smaller and the next writing is performed by the part with the worn writing lead. For this reason, it is not possible to achieve the inherent objective of the mechanical pencil provided with a rotation drive mechanism of preventing uneven wear of the writing lead. On the other hand, if there are less than 20 cam teeth, the length L of a cam tooth becomes larger. For this reason, from the above-mentioned relationship of the distance H=L tan θ, the distance H of the height of a cam tooth becomes larger and the minimum amount of retraction M also ends up becoming larger. For this reason, there are preferably 20 to 90 cam teeth.

If the outside diameter of the rotor 40 is made 4.8 mm, the number of cam teeth is made 90, and the slant angle θ is made 10.3° or larger than the friction angle of 10.2°, the length L of a cam tooth is about 0.17 mm since 4.8×π/90. This being the case, the distance H of the height of the cam tooth becomes 0.03 mm from the relationship of L tan θ. As a result, the minimum amount of retraction M, from the relationship of 3/2 H, becomes 0.05 mm.

Due to the above, if the amount of retraction “m” of the writing lead is smaller than the minimum amount of retraction M of 0.05 mm, the slant angle θ of a cam tooth becomes smaller, so the cam teeth are liable to not slide against each other and poor rotation is liable to occur or the rotational angle of the rotor 40 will become smaller, so it is liable to not be possible to achieve the inherent objective of the mechanical pencil provided with a rotation drive mechanism. Therefore, the amount of retraction “m” is preferably the 0.05 mm or more of the minimum amount of retraction M.

On the other hand, the amount of retraction “m” is preferably 0.3 mm or less. If the amount of retraction “m” is greater than 0.3 mm, a user is liable to feel odd due to retraction of the writing lead.

The inventors conducted a study on 23 students asking them to write using a mechanical pencil with an amount of retraction “m” of 0.15 mm and a mechanical pencil with an amount of retraction “m” of 0.3 mm without informing them of there being a difference in the amount of retraction “m”, whereupon the result was obtained that all noticed the difference. In short, it was learned that a user will feel it odd with a slight 0.15 mm difference. The amount of retraction “m” of the writing lead is preferably smaller, but, as explained above, if the amount of retraction “m” is too small, there is a liability of poor rotation. To prevent a user from feeling odd due to retraction of the writing lead as much as possible while reliably realizing operation of the rotor 40 and writing lead, the amount of retraction “m” is preferably 0.3 mm or less.

Due to the above, in a mechanical pencil 1 provided with a shaft barrel 5, a chuck unit 10 allowing advance and preventing retraction of the writing lead, and a rotation drive mechanism 30 having a rotor 40 and driving rotation of the rotor 40 in one direction upon receiving an axial direction retracting operation due to writing pressure received by the writing lead gripped at the chuck unit 10 and an axial direction advancing operation due to release of the writing pressure, the amount of retraction “m” of the writing lead is preferably 0.05 to 0.3 mm in range.

As explained above, if providing 90 cam teeth, the rotor rotates by exactly 4° by one cushion action. In the case of a user with a strong writing pressure, the amount of the writing lead worn by a single writing operation is also great. For this reason, rotation by 4° is sometimes not sufficient. To increase the rotational angle of the writing lead rotated by one cushion operation, there are more preferably 20 to 40 cam teeth, so, for example, if there are 40 cam teeth, 360° divided by 40 becomes 9°, so in one cushion operation, the rotor 40 rotates by exactly 9°. Therefore, if writing 40 times, the writing lead rotates by 1 turn.

If making the outside diameter of the rotor 40 the above-mentioned 4.8 mm, making the number of cam teeth 40 teeth, and making the slant angle θ 10.3°, the length L of a cam tooth is about 0.38 mm since 4.8×π/40. This being so, the distance H of the height of a cam tooth becomes 0.07 mm from the relationship of L tan θ. As a result, the minimum amount of retraction M becomes 0.1 mm from the relationship of 3/2 H.

Due to the above, if the amount of retraction “m” is 0.1 mm or more, even if a user with a strong writing pressure, sufficient rotation of the writing lead is obtained, so this is more preferable. Further, for a user, sometimes the writing surface is written against with the mechanical pencil 1 extremely slanted. In such a case, the larger the amount of retraction “m”, that is, the longer the length L of a cam tooth, or the larger the slant angle θ, the more reliable the coaction of the cam teeth can be made, so the more preferable. For such a reason as well, the amount of retraction “m” is preferably 0.1 mm or more.

In this regard, when writing a small text, since attention is paid to the front end of the writing lead and the sensation also becomes sharper, the amount of retraction “m” is preferably 0.2 mm or less. Further, even with the same cushion amount, the sensation felt at the time of writing by a 0.5 mm writing lead and the sensation felt at the time of writing by a 0.3 mm writing lead differ. That is, the sensation felt at the time of writing by a 0.3 mm writing lead easily feels more odd since the distance by which the front end of the writing lead moves back and forth feels relatively large compared with the thickness of the writing lead. For such a reason as well, the amount of retraction “m” is more preferably 0.2 mm or less.

Due to the above, the amount of retraction “m” of the writing lead is more preferably 0.1 to 0.2 mm in range.

Further, the amount of retraction “m” may be changed in accordance with the diameter of the writing lead and more preferably is about half or less of the outside diameter of the writing lead. For example, according to the JIS standard S600S of mechanical pencil leads, for example, a 0.5 mm writing lead is defined as being 0.55 to 0.58 mm. Therefore, in the case of a 0.5 mm writing lead, the amount of retraction “m” is preferably 0.3 mm or less. Similarly, a 0.3 mm writing lead is defined as 0.37 to 0.3 mm. Therefore, in the case of a 0.3 mm writing lead, the amount of retraction “m” is preferably 0.2 mm or less.

Note that, the cam teeth need not be continuous over the entire circumference. If considering the number of cam teeth, even if the cam teeth are not continuous over the entire circumference, but are arranged separated, it is possible to calculate the number of virtual cam teeth by dividing the length of the entire circumference by the length L in the circumferential direction of a single representative cam tooth. The number of the cam teeth is preferably 20, 40, 60, and 90 with respect to one circumference 360° of the rotor 40 so as to streamline design. Forty cam teeth are most preferable from the viewpoint of reduction of the amount of retraction “m”.

In the above embodiments, the minimum amount of retraction M and further the amount of retraction “m” of the writing lead were explained based on one example of the outside diameter of the rotor 40, the number of cam teeth, and the slant angle, but the preferred range of the amount of retraction “m” of the writing lead explained above can be similarly applied even in a mechanical pencil with another outside diameter, number of cam teeth, etc. That is, according to the above-mentioned embodiments, in a mechanical pencil 1 provided with a rotation drive mechanism for making the writing lead rotate, it is possible to make the amount of retraction of the writing lead decrease more.

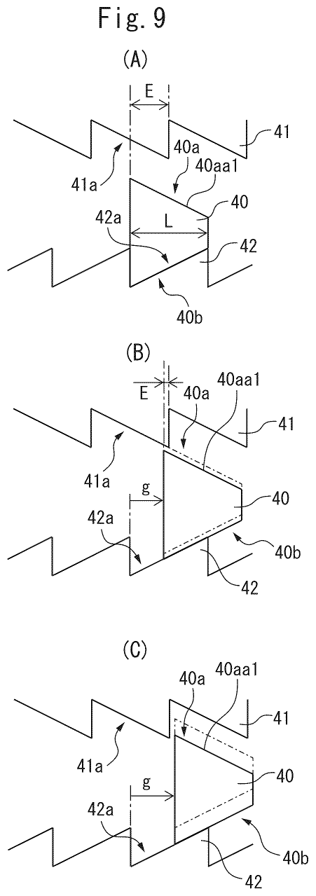

In this regard, making the length L of a first cam tooth 40aa shorter results in making the ratio of one first cam tooth 40aa with respect to the length of the entire circumference smaller. In other words, making the length L shorter results in the number of cam teeth being able to be increased. If making the length L shorter, the relative positional relationship of the rotor 40 with respect to the upper cam forming member 41 and lower cam forming member 42 becomes offset in the radial direction, that is, the center axes become offset from each other, whereby there is a possibility of the engagement of the cam teeth arranged at corresponding positions in a direction perpendicular to the offset direction becoming incomplete. As a result, there is a possibility of poor rotation of the rotor 40 occurring. This will be explained while referring to FIG. 8 and FIG. 9.

FIG. 8 is a view for explaining offset of the rotor 40 while FIG. 9 is a view for explaining poor rotation of the rotor 40. FIG. 8 is schematically drawn when viewing the rotation drive mechanism 30 from the axial direction while ignoring the scale etc. and exaggerating things somewhat. FIG. 8 shows the state where the rotor 40 is offset by exactly the distance “g” above the upper cam forming member 41 and lower cam forming member 42 in the figure. That is, the upper cam forming member 41 and lower cam forming member 42 are provided at the shaft barrel 5 side, so their center axes match, but just the center axis of the rotor 40 is offset by exactly the distance “g”.

FIG. 9(A) shows the relationship of the cams of the part P1 of FIG. 8 of the position where the rotor 40 is offset the most in the radial direction. FIG. 9(B) shows the relationship of the cams of the part P2 of FIG. 8 of the position where the rotor 40 is offset the most in the circumferential direction. That is, the part P1 is a part positioned in a direction in which the rotor 40 is offset, while the part P2 is a part positioned in a direction perpendicular to the offset direction. The cam teeth of the cams are arranged along the circumferential direction, so at the part P1, the cam teeth are arranged along the left-right direction in the figure while at the part P2, the cam teeth are arranged along the top-bottom direction in the figure.

Referring to FIG. 9(A), a cam tooth of the rotor 40 is offset with respect to the cam teeth of the upper cam forming member 41 and lower cam forming member 42, compared with the state shown in FIG. 6(A), by exactly a distance “g” in the radial direction of the rotor 40, that is, in the direction vertical to the paper surface in the figure. For this reason, at the part P1, there is no offset in the phase of the cam teeth, therefore, there is almost no effect on the rotation drive action of the rotor 40.

On the other hand, if referring to FIG. 9(B), a cam tooth of the rotor 40 is offset with respect to the cam teeth of the upper cam forming member 41 and lower cam forming member 42, compared with the state shown in FIG. 6(A), by exactly a distance “g” in the circumferential direction of the rotor 40, that is, in the right direction in the figure. Ordinarily, when writing causes the rotor 40 to retract, the first cam face 40a of the rotor 40 extends over a length of half of a first slanted surface 40aa1 of the rotor 40 and abuts against the first fixed cam face 41a of the upper cam forming member 41. That is, as shown in FIG. 6(B), the allowance E of the length of that part in the circumferential direction is ½ L.

On the other hand, due to the rotor 40 being offset by exactly the distance “g”, the allowance E becomes smaller by just that amount. For this reason, the first cam face 40a and the first fixed cam face 41a cannot reliably work together and poor rotation where the rotor 40 does not rotate is liable to occur. Further, as shown in FIG. 9(C), if the distance “g” is larger than half of the length L of a cam tooth of the first cam tooth 40aa, that is, if the rotor is offset by half a phase or more with respect to one tooth of the cam, the first cam face 40a also cannot abut against the corresponding first fixed cam face 41a to be abutted against. As a result, at other parts, even if a rotation drive force arises, rotation is restricted by that part and poor rotation where the rotor 40 does not rotate arises.

In short, the smaller the length L of a cam tooth relative to the distance “g” by which the rotor 40 is offset in the radial direction, the higher the possibility of poor rotation occurring. Therefore, offset of the rotor 40 in the radial direction is considered and the length L of the cam tooth and in turn the number of cam teeth are suitably determined in a range in which the above-mentioned amount of retraction “m” of the writing lead can be realized.

Note that, offset of the rotor 40 in the radial direction is greatly dependent on the clearance between the outer circumferential surface of the front end part of the slider 7 to which the rotor 40 is connected through the relay member 9 and the inner circumferential surface of the front shaft 2 surrounding that outer circumferential surface. The clearance is due to the allowable error at time of production, so preferably at least the slider 7 is made of metal so as to enable more precise working.

The first cam tooth 40aa of the rotor 40 in the above embodiments has a first slanted surface 40aa1 and a vertical surface 40aa2 corresponding to a second slanted surface. For this reason, the first cam face 40a is formed into a continuous so-called sawtooth shape. The other cam teeth are similarly shaped. For example, the mechanical pencil described in PTL 1 is similarly shaped. The cam teeth can drive the rotor to rotate even if not a sawtooth shape. Below, other shapes of cam teeth will be explained.

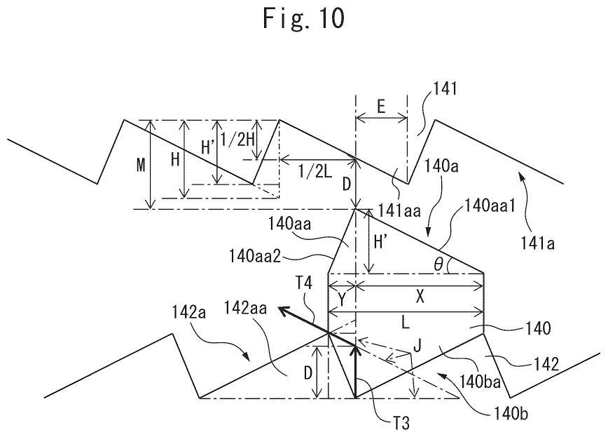

FIG. 10 is a schematic view for explaining the relationship of cams in another rotation drive mechanism and is a view corresponding to FIG. 7. The rotation drive mechanism shown in FIG. 10 has a rotor 140, upper cam forming member 141, and lower cam forming member 142 and can replace the rotor 40, upper cam forming member 41, and lower cam forming member 42 of the above-mentioned rotation drive mechanism 30.

The first cam tooth 140aa of the first cam face 140a has a first slanted surface 140aa1 and a second slanted surface 140aa2. Due to the first slanted surface 140aa1 and second slanted surface 140aa2 of the adjoining first cam tooth 140aa, the first cam face 140a is formed into a continuous peak shape. The first slanted surface 140aa1 is a surface slanted by a slant angle θ with respect to a transverse direction perpendicular to the axial direction. The second cam teeth 140ba of the second cam face 140b, the first fixed cam tooth 141aa of the first fixed cam face 141a, and the second fixed cam tooth 142aa of the second fixed cam face 142a have similar shapes as the first cam teeth 140aa.

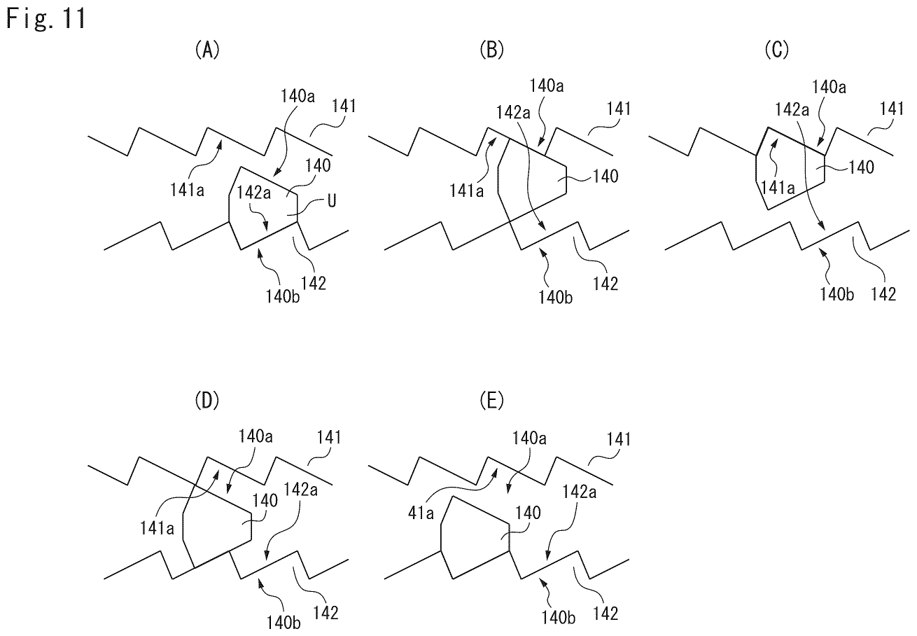

FIG. 11 is a schematic view for explaining in order a rotation drive action of the rotor 140 of the rotation drive mechanism of FIG. 10. FIGS. 11(A) to (E) are schematic views corresponding to FIGS. 6(A) to (E). The basic motions are the same. FIG. 11 partially shows the state of the rotor 140, upper cam forming member 141, and lower cam forming member 142 spread out in the circumferential direction. Further, to enable the cushion operation to be understood more easily, the cam teeth of the rotor 140 will be explained referring to a unit U of a single cam tooth in the same way as FIG. 6.

FIG. 11(A) shows the relationship of the advancing rotor 140, upper cam forming member 141 and lower cam forming member 142 in the state where writing pressure is not applied to the writing lead. In this state, the second cam face 140b formed at the rotor 140 abuts against the second fixed cam face 142a of the lower cam forming member 142 due to the biasing force of the cushion spring 45. At this time, the first cam face 140a of the rotor 140 and the first fixed cam face 141a of the upper cam forming member 141 are set so as to be offset in the axial direction by half a phase with respect to one tooth of the cam.

FIG. 11(B) shows the initial stage where writing pressure is applied to the writing lead for writing by the mechanical pencil 1. In this state, the rotor 140 retracts while compressing the cushion spring 45 along with retraction of the chuck unit 10. Due to this, the rotor 140 moves to the upper cam forming member 141 side and abuts against the first fixed cam face 141a.

Next, FIG. 11(C) shows the state where writing pressure is further applied to the writing lead and the rotor 140 abuts against the first fixed cam face 141a of the cam forming member 141 and slides against it while retracting. That is, the rotor 140 receives a rotation drive action corresponding to half a phase of one tooth of the first cam face 140a. In this state, the first cam face 140a of the rotor 140 engages with the first fixed cam face 141a of the upper cam forming member 141.

Next, FIG. 11(D) shows the initial state where writing by the mechanical pencil 1 ends and the writing pressure on the writing lead is released. In this state, the rotor 140 advances due to the biasing force of the cushion spring 45. Due to this, the rotor 140 moves to the lower cam forming member 142 side and abuts against the second fixed cam face 142a.

Next, FIG. 11(E) shows the state where the rotor 140 abuts against the second fixed cam face 142a of the lower cam forming member 142 due to the biasing force of the cushion spring 45 and slides against it while advancing. That is, the rotor 140 again receives a rotation drive action corresponding to half a phase of one tooth of the second cam face 140b. In this state, the second cam face 140b of the rotor 140 engages with the second fixed cam face 142a of the lower cam forming member 142.

Therefore, along with the reciprocating motion in the axial direction of the rotor 140 receiving the writing pressure, that is, front-back motion, the rotor 140 receives a rotation drive action corresponding to one tooth of the first cam face 140a and second cam face 140b. Through the chuck unit 10, the writing lead gripped by this is driven to rotate in the same way. In short, both if the shape of the cam tooth is a sawtooth shape or is a peak shape, there is no difference in the basic rotation drive action of the rotation drive mechanism.

Referring to FIG. 10, the calculation of the minimum amount of retraction M will be explained. The height of a sawtooth-shaped cam tooth shown in FIG. 7 is made the distance H, while the height of a peak-shaped cam tooth shown in FIG. 10 is made the distance H′. In FIG. 10, the sawtooth-shaped cam tooth shown in FIG. 7 is shown by the imaginary lines. The movement distance until the front end of the first cam tooth 140aa abuts against the first fixed cam tooth 141aa due to retraction of the rotor 140 is made the distance D. The length along the circumferential direction of the first cam tooth 140aa is made the length L of the cam tooth. When considering the triangular shape of the first cam tooth 140aa and drawing a vertical from the vertex to the bottom side to divide the length L, the length of the bottom side of the rear side with respect to the rotational direction of the rotor 140 (left direction in figure) is made X, and the length of the bottom side of the front side with respect to the rotational direction of the rotor 140 is made Y.

The distance H of the sawtooth-shaped cam tooth and the distance H′ of the peak-shaped cam tooth are geometrically in the relationship H′=HX/(X+Y). Further, in considering the plurality of auxiliary lines J of the part of the second cam tooth 140ba of FIG. 10, the distance D becomes D=H−2 H(Y/(X+Y))=H(X−Y)/(X+Y). From these, the minimum amount of retraction M becomes the relationship M=½ H+D=½ H+H(X−Y)/(X+Y)=H(3X−Y)/{2(X+Y)}=H′(3X−Y)/(2X). Therefore, the relationship of the minimum amount of retraction M= 3/2 H′−H′Y/(2X) is sought. In the case of a sawtooth-shaped cam tooth with a height of the cam tooth shown in FIG. 7 of the distance H, Y is zero, so according to that relationship, as explained above, the minimum amount of retraction M= 3/2 H.

Note that, if focusing on the motion of the front end of the peak of a second cam tooth 140ba of the second cam face 140b, when first retracting, it moves along the path T3, then moves along the path T4 due to subsequent rotation and retraction. The first cam tooth 140aa of the first cam face 140a moves while following a similar path as this.

The first cam tooth 140aa becomes an isosceles triangle when X=Y. Such a cam tooth is disclosed in FIG. 4 of PTL 2. In this case, from the relationship of the minimum amount of retraction M= 3/2 H′−H′Y/(2X), the minimum amount of retraction M becomes H′. The minimum amount of retraction M becomes the smallest. However, as clear if considering the case where X=Y while referring to FIG. 10, the vertex of the first cam tooth 140aa and the vertex of the first fixed cam tooth 141aa are arranged at facing positions. For this reason, the allowance E becomes miniscule or spotty. There is a possibility of poor rotation occurring due to just slight offset in the radial direction of the rotor 140.

Therefore, Y is preferably smaller than X. Further, the first cam tooth 140aa, from the above relationship, not being a first cam tooth 40aa of a sawtooth shape comprised of a right triangle such as shown in FIG. 7 enables the minimum amount of retraction M to be made smaller. Therefore, Y is preferably greater than zero,

From the above, the first cam tooth 140aa and second cam tooth 140ba are preferably configured so that the relationship of 0<Y<X stands where, with respect to the vertex of the first cam tooth 140aa or the vertex of the second cam tooth 140ba, a length of a bottom side at a rear side in a rotational direction of the rotor 140 is X and a length of a bottom side at a front side in a rotational direction of the rotor 140 is Y. Further, preferably the mechanical pencil is configured so that the first fixed cam face 141a and the second fixed cam face 142a are arranged at a shortest distance at which rotation of the rotor 140 is not obstructed. Due to this, it is possible to reduce more the minimum amount of retraction M and in turn the amount of retraction “m” of the writing lead while securing a greater necessary allowance E.

In this regard, if considering the allowable error at the time of production, the allowance E is preferably 0.1 mm or more (E≥0.1 mm). In relation to this, consider the case where there are 40 cam teeth and, as explained above, the outside diameter of the part of the first cam face 140a and second cam face 140b of the rotor 140 is 4.8 mm. Further, the explanation will be given corresponding to the rotational angles about the center axis of the mechanical pencil 1 or the rotor 140 for different dimensions.

When there are 40 cam teeth, the rotational angle α corresponding to half a phase of one tooth of the cam becomes 360/40/2=4.5°. The rotational angle β corresponding to the allowance E of 0.1 mm, from the relationship of 4.8 mm×π×β/360=0.1, becomes 2.4°. Referring to FIG. 10, regarding the bottom side of the first cam tooth 140aa explained above, if considering an isosceles triangle where X=Y, if the vertex of the first cam tooth 140aa is offset 1.2° in the left direction in the figure and the facing first fixed cam tooth 141aa is offset 1.2° in the right direction in the figure, relatively the rotational angle becomes a total of 2.4° and the allowance E becomes 0.1 mm. Regarding the length of the bottom side of the first cam tooth 140aa at this time, since the rotational angle corresponding to X is a rotational angle of 9.0° corresponding to one tooth of the cam, 9.0/2+1.2=5.7° and the rotational angle corresponding to Y becomes 9.0/2−1.2=3.3°. Therefore, to make the allowance E≥0.1 mm, preferably X/Y≥5.7/3.3=1.72.

Due to the above, the first cam tooth 140aa and second cam tooth 140ba are preferably configured so that the relationship of X/Y≥1.72 stands. Further, to more reliably prevent poor rotation due to offset in the radial direction of the rotor 140, the first cam tooth 140aa and second cam tooth 140ba are more preferably configured so that the relationship of X/Y≥2.0 stands. Further, even in the case of a cam tooth in the above-mentioned relationship of X and Y, as explained above, the amount of retraction of the writing lead due to the retracting operation is preferably 0.05 to 0.3 mum in range and is more preferably is 0.1 to 0.2 mm in range.

In the embodiment explained above, the preferred shape of a cam tooth, i.e., the relationship of X and Y, was explained based on one example of the outside diameter of the rotor 140, the number of cam teeth, and slant angle, but the above-mentioned relationship of X and Y can similarly be applied even in a mechanical pencil with other outside diameters, numbers of cam teeth, etc. That is, according to the above-mentioned embodiments, in a mechanical pencil 1 provided with a rotation drive mechanism for making the writing lead rotate, it is possible to make the amount of retraction of the writing lead decrease more.

### REFERENCE SIGNS LIST

1 mechanical pencil
5 shaft barrel
10 chuck unit
20 click member
31 shaft spring
40 rotor
40a first cam face
40aa first cam tooth
40b second cam face
40ba second cam tooth
41 upper cam forming member
41a first fixed cam face
41aa first fixed cam tooth
42 lower cam forming member
42a second fixed cam face
42aa second fixed cam tooth
140 rotor
140a first cam face
140aa first cam tooth
140b second cam face
140ba second cam tooth
141 upper cam forming member
141a first fixed cam face
141aa first fixed cam tooth
142 lower cam forming member
142a second fixed cam face
142aa second fixed cam tooth
M minimum amount of retraction

1. A mechanical pencil comprising
a shaft barrel,
a chuck unit allowing advance and preventing retraction of a writing lead, and
a rotation drive mechanism having a rotor and receiving an axial direction retracting operation due to writing pressure received by the writing lead gripped by the chuck unit and axial direction advancing operation due to release of the writing pressure to make the rotor be driven to rotate in one direction,
the rotation drive mechanism having a ring-shaped first cam face formed at a rear end face of the rotor, a ring-shaped second cam face formed at a front end face of the rotor, a first fixed cam face provided at the shaft barrel side and cooperating with the first cam face to make the rotor rotate, and a second fixed cam face provided at the shaft barrel side and cooperating with the second cam face to make the rotor rotate,
the retracting operation of the chuck unit due to the writing pressure causing the first cam face of the rotor to abut against the first fixed cam face and engage with it while making the rotor rotate and the release of the writing pressure causing the second cam face of the rotor to abut against the second fixed cam face and engage with it while making the rotor rotate,
in the state where the first cam face of the rotor is made to engage with the first fixed cam face, the second cam face and the second fixed cam face being set to a relationship offset in the axial direction by exactly half a phase with respect to one tooth of the cam, while in the state where the second cam face of the rotor is made to engage with the second fixed cam face, the first cam face and the first fixed cam face being set to a relationship offset in the axial direction by exactly half a phase with respect to one tooth of the cam,
the first cam face provided with first cam teeth, the second cam face provided with second cam teeth,
the first fixed cam face provided with first fixed cam teeth cooperating with the first cam teeth, and the second fixed cam face with second fixed cam teeth cooperating with the second cam teeth, the first cam teeth configured so that when,
at the first cam teeth, with respect to a vertical drawn from the vertex, a length of a bottom side at a rear side with respect to a rotational direction of the rotor is X and a length of a bottom side at a front side with respect to a rotational direction of the rotor is Y, the relationship of 0<Y<X stands.

2. The mechanical pencil according to claim 1, wherein the first cam teeth and the second cam teeth are configured so that the relationship of X/Y≥1.72 stands.

3. The mechanical pencil according to claim 2, wherein the first cam teeth and the second cam teeth are configured so that the relationship of X/Y≥2.0 stands.

4. The mechanical pencil according claim 1, wherein in the state where the second cam face of the rotor is made to engage with the second fixed cam face, the vertexes of the first cam face and the vertexes of the first fixed cam face are separated by 0.1 mm or more in the circumferential direction.

5. The mechanical pencil according to claim 1, wherein the first fixed cam face and the second fixed cam face are arranged at a shortest distance at which rotation of the rotor is not obstructed.

6. The mechanical pencil according to claim 1, wherein the writing lead rotates by the chuck unit rotating receiving the rotation drive force of the rotor.
